(19) United States
(12) Patent Application Publication
(10) Pub. No.: US 2025/0065643 A1
(43) Pub. Date: Feb. 27, 2025

(54) LED CONTROL APPARATUS, IMAGE PRINTING APPARATUS, AND LED CONTROL METHOD

(71) Applicant: CANON KABUSHIKI KAISHA, Tokyo (JP)

(72) Inventors: KOTARO KIMOTO, Kanagawa (JP); HIRONORI NAKA, Tokyo (JP)

(21) Appl. No.: 18/802,008

(22) Filed: Aug. 13, 2024

(30) Foreign Application Priority Data
Aug. 22, 2023 (JP) 2023-134531

(51) Int. Cl. B41J 2/45; H05B 45/14

(52) U.S. Cl. CPC B41J 2/45; H05B 45/14

(57) ABSTRACT

Provided is a light emitting diode (LED) control apparatus including: an LED; a power supply that supplies electric power to the LED; a first adjustment unit that outputs a first voltage which is less than a predetermined voltage to the LED; a second adjustment unit that outputs a second voltage which is more than or equal to the predetermined voltage to the LED; a switching unit that switches a connection destination for the LED to the first adjustment unit or to the second adjustment unit; a control unit that controls the connection destination of the switching unit; a detection circuit that, in a case where the first adjustment unit is connected to the LED and outputs the first voltage, detects a flow of a current of a larger value than a predetermined range of current values through a circuit to which the LED is connected.

### BACKGROUND OF THE INVENTION

### Field of the Invention

The present disclosure relates to a light emitting diode (LED) control apparatus and specifically to a technique for detecting an overcurrent due to a short circuit or the like in any of multiple LED lighting devices.

### Description of the Related Art

Display apparatuses including LEDs as light sources combine those LEDs, which emit red (hereinafter referred to as “R”), green (hereinafter referred to as “G”), and blue (hereinafter referred to as “B”) light beams, and control the luminance of each of the R, G, and B LEDs according to a luminance signal to express a desired color. Since such a display apparatus causes multiple LEDs to emit light beams to express a single color, the display apparatus will emit light of a color that is not a desired color in case of a failure of one of those multiple LEDs or a component for the light emission of that LED.

Japanese Patent Laid-Open No. 2007-108519 (hereinafter referred to as “Document 1”) discloses a failure detection unit that, in case of a failure of any of R, G, and B LEDs included in an LED cluster, detects the failure, and a current detection unit that stops the supply of currents to all LEDs to turn them off in a case where the failure detection unit detects a failure of any of the LEDs.

### SUMMARY OF THE INVENTION

Here, in Document 1 mentioned above, failures can be detected only while the LEDs emit light. This leads to a problem that the LEDs emit light of an unintended color in the period from the detection of the failure until the LEDs are turned off as a result of stopping the supply of currents.

To address this, an LED control apparatus in the present disclosure includes: an LED; a power supply that supplies electric power to the LED; a first adjustment unit that outputs a first voltage which is less than a predetermined voltage to the LED; a second adjustment unit that outputs a second voltage which is more than or equal to the predetermined voltage to the LED; a switch control unit that switches a connection destination for the LED to the first adjustment unit or to the second adjustment unit; and a detection circuit that, in a case where the first adjustment unit is connected to the LED by the switch control unit and outputs the first voltage, detects a flow of a current of a larger value than a predetermined range of current values through a circuit to which the LED is connected.

Further features of the present invention will become apparent from the following description of exemplary embodiments with reference to the attached drawings.

### BRIEF DESCRIPTION OF THE DRAWINGS

FIG. 1 illustrates a block diagram of an image printing apparatus to which the present disclosure is applied;

FIG. 2 illustrates a configuration diagram of an LED control circuit in Embodiment 1 of the present disclosure;

FIG. 3 illustrates a flowchart in Embodiment 1 of the present disclosure;

FIG. 4 illustrates a configuration diagram of an LED control circuit in Embodiment 2 of the present disclosure;

FIG. 5 illustrates a flowchart in Embodiment 2 of the present disclosure;

FIG. 6 illustrates a configuration diagram of an LED control circuit in Embodiment 3 of the present disclosure; and

FIG. 7 illustrates a flowchart in Embodiment 3 of the present disclosure.

### DESCRIPTION OF THE EMBODIMENTS

The descriptions of the following embodiments are nothing more than specific descriptions of mere exemplary embodiments of the present disclosure made to the greatest possible extent in order to fulfill the description requirements (written description requirement and enablement requirement) of the description required by law. Thus, as described later, the present disclosure is not limited in any way to the specific configurations in the embodiments described below.

### Embodiment 1

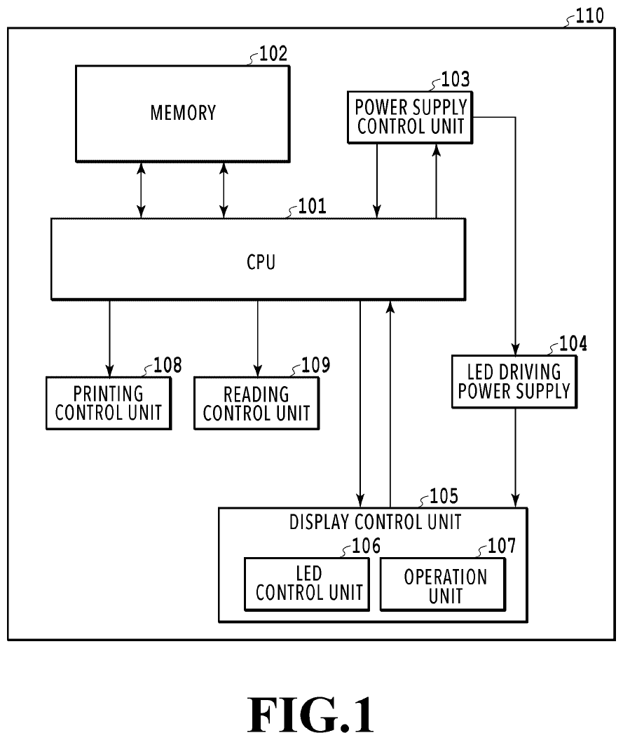

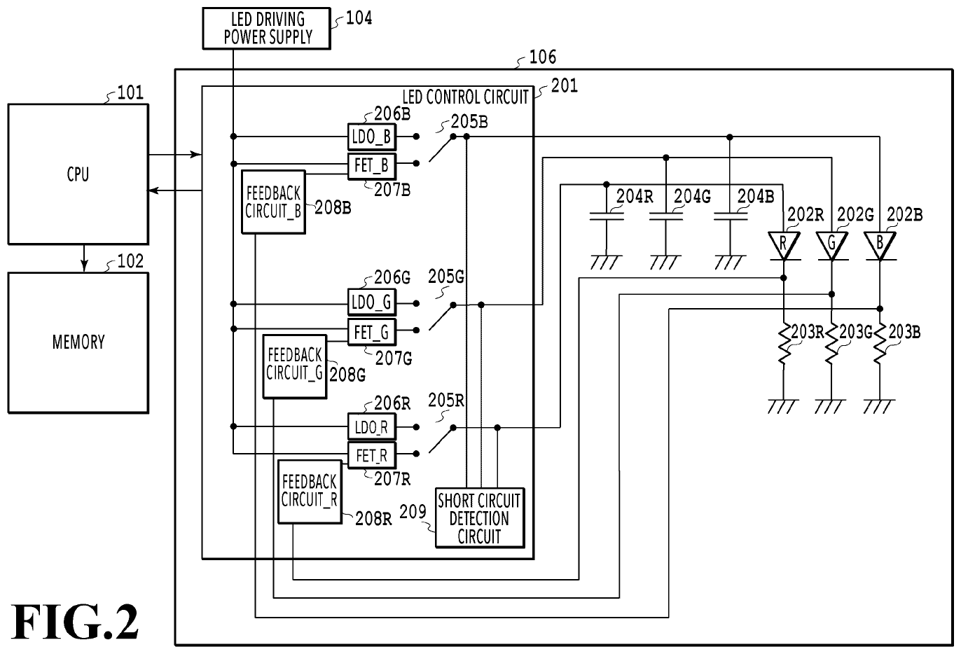

FIG. 1 is a block diagram illustrating a configuration of an image printing apparatus 110 according to Embodiment 1. The image printing apparatus 110 according to the present embodiment includes a CPU 101 and a memory 102. The CPU 101 executes processes and controls a printing control unit 108 and a reading control unit 109 in accordance with programs held in the memory 102. The memory 102 includes a combination of a volatile storage and a non-volatile storage, for example, and is used to temporarily hold programs and data in the volatile storage and to hold programs and parameters in the non-volatile storage. A display control unit 105 includes an LED control unit 106 and an operation unit 107. The operation unit 107 includes keys and a touch panel and receives user operations to switch the function and operation of the image printing apparatus 110. The operation unit 107 is also provided with multiple LEDs for notifying the user of the operation mode and error status of the image printing apparatus 110 by optical display, and this display with these LEDs is controlled by the LED control unit 106. In the present embodiment, the LED control unit 106 expresses a desired color by controlling the luminance of each of the R, G, and B LEDs, as will be described later with reference to FIG. 2. A power supply control unit 103 that generates and controls a power supply for the entire circuitry of the image printing apparatus 110 supplies an LED driving power supply 104 to the LED control unit 106.

FIG. 2 is a circuit configuration diagram illustrating details of the circuit of the LED control unit 106 in FIG. 1. As components of the LED control unit 106, an LED 202R that emits red light, an LED 202G that emits green light, and an LED 202B that emits blue light (hereinafter simply referred to collectively as “LEDs 202” as well). Further, in the LED control unit 106 in the present embodiment, a current restriction resistor 203R is connected between the cathode of the LED 202R and GND, a current restriction resistor 203G is connected between the cathode of the LED 202G and the GND, and a current restriction resistor 203B is connected between the cathode of the LED 202B and the GND. Also, a feedback control capacitor 204R is connected to a node between a LED control circuit 201 and the LED 202R and to the GND. A feedback control capacitor 204G is connected to a node between the LED control circuit 201 and the LED 202G and to the GND. A feedback control capacitor 204B is connected to a node between the LED control circuit 201 and the LED 202B and to the GND. The LED control circuit 201 is a circuit that performs constant current control on the LEDs 202R, 202G, and 202B by using feedback control. An operation for that will now be described below.

In the LED control circuit 201, a switch (SW) 205R is connected to the anode of the LED 202R, an SW 205G is connected to the anode of the LED 202G, and an SW 205B is connected to the anode of the LED 202B. The SW 205R switches the circuit connection to a corresponding low-dropout regulator (LDO) 206R or a corresponding field effect transistor (FET) 207B in the LED control circuit 201. The SW 205G switches the circuit connection to a corresponding LDO 206G or a corresponding FET 207G in the LED control circuit 201. The SW 205B switches the circuit connection to a corresponding LDO 206B or a corresponding FET 207R in the LED control circuit 201. Also, the LDOs 206R, 206G, and 206B or the FETs 207B, 207G, and 207R are supplied with power supplies from the LED driving power supply 104.

In a case of causing the LEDs 202 to emit light, the SWs 205R, 205G, and 205B are connected to the FETs 207R, 207G, and 207B, respectively. Feedback circuits 208R, 208G, and 208B are connected to the FETs 207R, 207G, and 207B, respectively. The feedback circuits 208R, 208G, and 208B monitor the voltages at the ends of the cathodes of the LED 202R, 202G, and 202B, respectively. The feedback circuit 208R operates so as to keep the FET 207R turned on until the value of the voltage at the end of the cathode of the LED 202R reaches or exceeds a predetermined voltage value. The feedback circuit 208G operates so as to keep the FET 207G turned on until the value of the voltage at the end of the cathode of the LED 202G reaches or exceeds a predetermined voltage value. The feedback circuit 208B operates so as to keep the FET 207B turned on until the value of the voltage at the end of the cathode of the LED 202B reaches or exceeds a predetermined voltage value. Also, the feedback circuit 208R operates so as to keep the FET 207R turned off until the value of the voltage at the end of the cathode of the LED 202R reaches or falls below the predetermined voltage value. The feedback circuit 208G operates so as to keep the FET 207G turned off until the value of the voltage at the end of the cathode of the LED 202G reaches or falls below the predetermined voltage value. The feedback circuit 208B operates so as to keep the FET 207B turned off until the value of the voltage at the end of the cathode of the LED 202B reaches or falls below the predetermined voltage value. Each FET is repetitively switched on and off with the predetermined voltage value as a threshold value as described above to maintain the voltage on the cathode side of the LED at the predetermined voltage value. In the present embodiment, the predetermined voltage value represents a voltage value that determines the luminance of light to be emitted by the LED. Specifically, the luminance of light emitted by an LED is determined by the value of the current flowing through the LED. Thus, in the present embodiment, the luminance of light emitted by each LED is defined by “the value of the current flowing through the LED=the predetermined voltage value/the value of the resistance of the restriction resistor 203”. That is, each FET forms a second adjustment unit that outputs a second voltage of the predetermined voltage value or more to the LED, and the luminance of light to be emitted by the LED can be controlled by setting this predetermined voltage value to a desired voltage value.

On the other hand, in a case of performing LED short circuit detection, the SWs 205R, 205G, and 205B are connected to the LDOs 206R, 206G, and 206B, respectively. The output voltage of the LDO 206R is variable. Thus, in the case of performing the LED short circuit detection, the LDO 206R outputs the value of its output voltage as a voltage (first voltage) that is less than a voltage Vf for the LED 202R (a forward voltage necessary for the LED 202 to emit light). The output voltage of the LDO 206G is variable. Thus, in the case of performing the LED short circuit detection, the LDO 206G outputs the value of its output voltage as a voltage (first voltage) that is less than a voltage Vf for the LED 202G. The output voltage of the LDO 206B is variable. Thus, in the case of performing the LED short circuit detection, the LDO 206B outputs the value of its output voltage as a voltage (first voltage) that is less than a voltage Vf for the LED 202B. In this sense, each of the LDOs 206R, 206G, and 206B is a first adjustment unit for adjusting the voltage. The LEDs 202R, 202G, and 202B do not emit light with the voltages output from the LDOs 206R, 206G, and 206B in this state. However, in a case where any of the LEDs 202R, 202G, and 202B or any of the capacitors 204R, 204G, and 204B, which are circuit elements for driving them, is experiencing a short circuit failure, a current larger than that in the normal state (overcurrent) will be generated. A short circuit detection circuit 209 is such that the value of a current that flows therethrough is 0 A in the normal state, for example. In case of a short circuit failure, a current of a particular threshold value or more flows through the short circuit detection circuit 209. This enables the short circuit detection circuit 209 to detect the short circuit. This short circuit detection circuit is typically implemented with an overcurrent detection circuit or a low-voltage malfunction prevention circuit. Note that while the configuration in the above embodiment is such that each LDO (first adjustment unit) and the corresponding FET (second adjustment unit) are separate control elements and the corresponding SW switches between their outputs, the application of the present invention is not limited to this configuration. The LDO and the FET may be configured as a single control element and output individual voltages. That is, this single control element has a function of selectively adjusting the power supply voltage to the voltage Vf for causing the LED to emit light or to a voltage lower than the voltage Vf, and outputs one of those voltages based on whether to cause the LED to emit light or to perform short circuit detection.

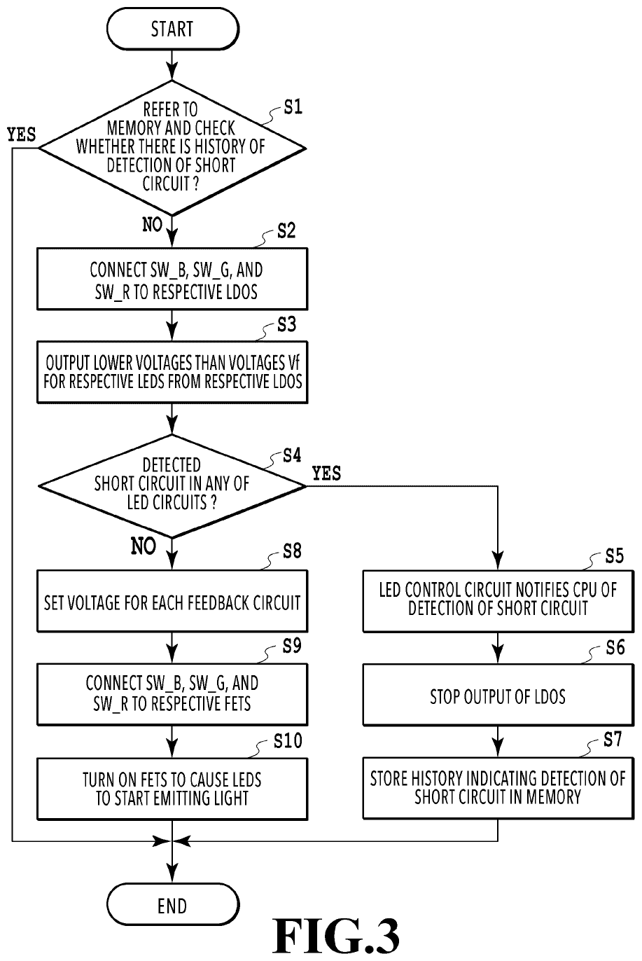

As described above, the LED control circuit in the present embodiment is capable of performing short circuit detection on the LEDs without causing the LEDs to emit light. Incidentally, during normal light emission, currents of around the above threshold values flow through the circuit. For this reason, it is preferable for disable the short circuit detection function during normal light emission in order to prevent false detection. That is, as will be described later with reference to FIG. 3, short circuit detection is performed at a timing at which the image printing apparatus 110 shifts from an off state to an on state.

The CPU 101 serves as a controller of the LED control circuit 201. The CPU 101 switches the SWs 205R, 205G, and 205B, sets predetermined values for the feedback circuits 208R, 208G, and 208B, and sets the values of the output voltages of the LDOs 206R, 206G, and 206B. Further, the CPU 101 is notified of the result of short circuit detection from the LED control circuit 201. The memory 102 is connected to the CPU 101 and records the result of the short circuit detection result received by the CPU 101.

A flow for performing short circuit detection on the LEDs 202 and lighting the LEDs in the present embodiment will now be described below with FIG. 3. The timing for implementing the short circuit detection flow in FIG. 3 is desirably a timing at which the image printing apparatus 110 illustrated in FIG. 1 shifts from the off state to the on state. Step S1 is a step of referring to the memory and checking whether there is a history of detection of a short circuit. Specifically, the corresponding region in the memory 102 is referred to to check the presence of a history of detection of a short circuit in the past. If Yes, no subsequent operation is performed, and the flow is terminated. If No, then in step S2, the SWs 205R, 205G, and 205B are connected to the LDOs 206R, 206G, and 206B, respectively. Subsequently, step S3 is a step of outputting a voltage set to be lower than the voltage Vf for the LED 202R from the LDO 206R, outputting a voltage set to be lower than the voltage Vf for the LED 202G from the LDO 206G, and outputting a voltage set to be lower than the voltage Vf for the LED 202B from the LDO 206B.

In step S4, it is checked whether a short circuit has been detected in any of the LED circuits. If the short circuit detection circuit 209 has detected a short circuit, the LED control circuit 201 notifies the CPU 101 of the detection of the short circuit in step S5. Then, in step S6, the output of the voltages from all of the LDOs 206R, 206G, and 206B is stopped. In step S7, the CPU 101 stores history information indicating the detection of the short circuit in the corresponding region in the memory 102.

If the short circuit detection circuit 209 detects no short circuit in step S4, predetermined voltages for the feedback circuits 208R, 208G, and 208B are set in step S8. Then, in step S9, the SWs 205R, 205G, and 205B are connected to the FETs 207R, 207G, and 207B, respectively. Thereafter, in step S10, in order to turn on the FETs 207R, 207G, and 207B, voltages higher than the voltages Vf for the respective LEDs are applied, so that the LEDs 202R, 202G, and 202B start emitting light.

Incidentally, in a case where a history of detection of a short circuit has been stored in the memory, such as Yes in step S1 or after step S7, a display unit included in the image printing apparatus 110, an external terminal (not illustrated) operated by the user, or the like may be notified of the presence of an abnormality.

By performing the above short circuit detection sequentially on the R, G, and B LED circuits, it is possible to identify an LED circuit(s) with a short circuit failure. On the other hand, by performing the detection on all of the R, G, and B circuits at the same time, it is possible to check only whether a short circuit failure has occurred, and accordingly shorten the detection time. In the case of performing the short circuit detection on all of the R, G, and B circuits at the same time, voltages are simultaneously output from the LDOs 206R, 206G, and 206B and applied to the respective LEDs and, at this time, the short circuit detection circuit is used to detect a current value. In this case, the detected value is 0 A if none of the LEDs is experiencing a short circuit failure. If one or more of the LEDs are experiencing a short circuit failure, a current of the threshold value or more flows, so that the short circuit(s) can be detected. Also, the short circuit detection circuit may be provided individually for each LED circuit. In this case, it is possible to perform short circuit detection on all of the R, G, and B circuits at the same time while also identifying an LED(s) with a short circuit failure.

### Embodiment 2

This section is identical to Embodiment 1 in many parts. Thus, only the differences in structure and operation from the configuration in Embodiment 1 will be described using drawings.

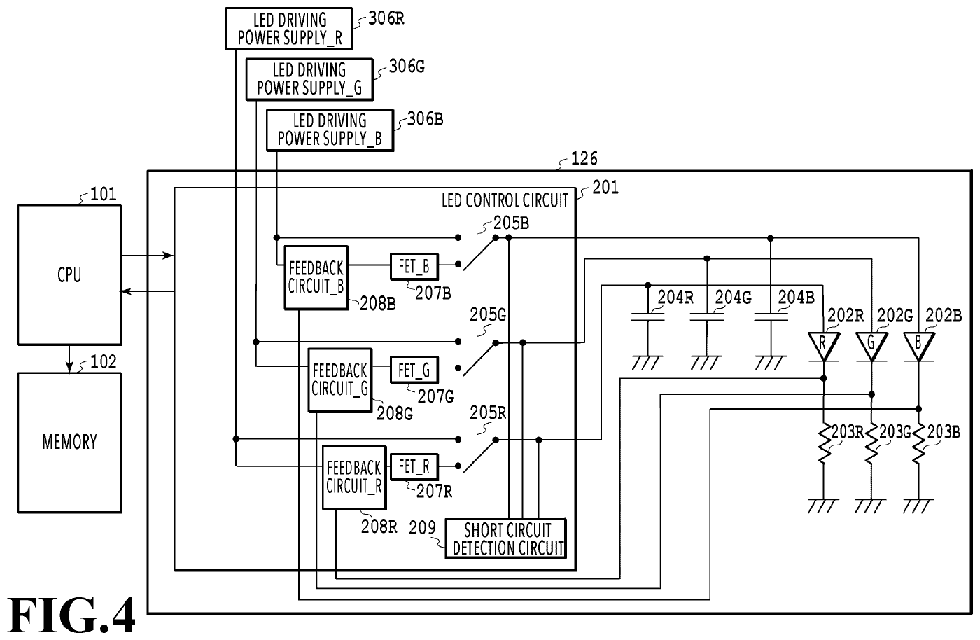

FIG. 4 is a circuit configuration diagram illustrating details of the circuit of an LED control unit 126 in Embodiment 2 corresponding to the LED control unit 106 in FIG. 1. The circuit configuration differs from that Embodiment 1 in that LED driving power supplies 306R, 306G, and 306B are connected to the SWs 205R, 205G, and 205B in the LED control circuit 201, respectively, and the LDOs 206R, 206G, and 206B present in Embodiment 1 are not present. In addition, the LED driving power supplies 306R, 306G, and 306B in Embodiment 2 are variable voltage sources. In a case of performing LED short circuit detection in Embodiment 2, the SWs 205R, 205G, and 205B are directly connected to the LED driving power supplies 306R, 306G, and 306B, respectively. The LED driving power supplies 306R, 306G, and 306B each function as a first adjustment unit to output a voltage lower than the voltage Vf for the corresponding LED. In this way, LED short circuit detection can be performed with equivalent units to that described in Embodiment 1 without causing the LED to emit light. On the other hand, in a case of causing the LEDs to emit light, the LED driving power supplies 306R, 306G, and 306B each function as a second adjustment unit together with the corresponding FET to output a voltage higher than the voltage Vf for the corresponding LED.

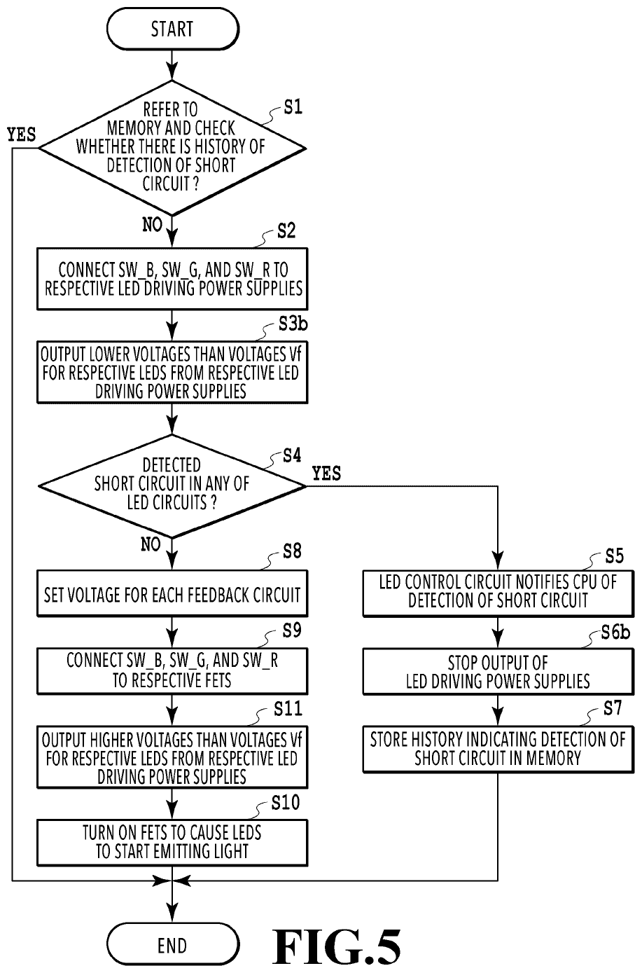

A flow for performing short circuit detection on the LEDs and lighting the LEDs in Embodiment 2 will now be described below with FIG. 5 focusing only on the differences from Embodiment 1. As in Embodiment 1, the timing for implementing the short circuit detection flow in FIG. 5 is desirably a timing at which the image printing apparatus 110 illustrated in FIG. 1 shifts from the off state to the on state. If No in step S1, then in step S2, the SWs 205R, 205G, and 205B are directly connected to the LED driving power supplies 306R, 306G, and 306B, respectively. In step S3b, the LED driving power supplies 306R, 306G, and 306B output voltages lower than the voltages Vf for the respective LEDs. If the short circuit detection circuit 209 detects a short circuit in step S4, the LED control circuit 201 notifies the CPU 101 of the detection of the short circuit in step S5. Then, in step S6b, the output of the voltages from all of the LED driving power supplies 306R, 306G, and 306B is stopped. In step S7, the CPU 101 stores history information indicating the detection of the short circuit in the corresponding region in the memory 102.

If the short circuit detection circuit 209 detects no short circuit in step S4, predetermined voltages for the feedback circuits 208R, 208G, and 208B are set in step S8, as in Embodiment 1. Then, in step S9, the SWs 205R, 205G, and 205B are connected to the FETs 207R, 207G, and 207B, respectively. In step S11, the LED driving power supplies 306R, 306G, and 306B output voltages higher than the voltages Vf for the respective LEDs. Thereafter, in step S10, the FETs 207R, 207G, and 207B are turned on, so that the LEDs 202R, 202G, and 202B start emitting light.

### Embodiment 3

This section is identical to Embodiment 1 in many parts. Thus, only the differences in structure and operation from the configuration in Embodiment 1 will be described using drawings.

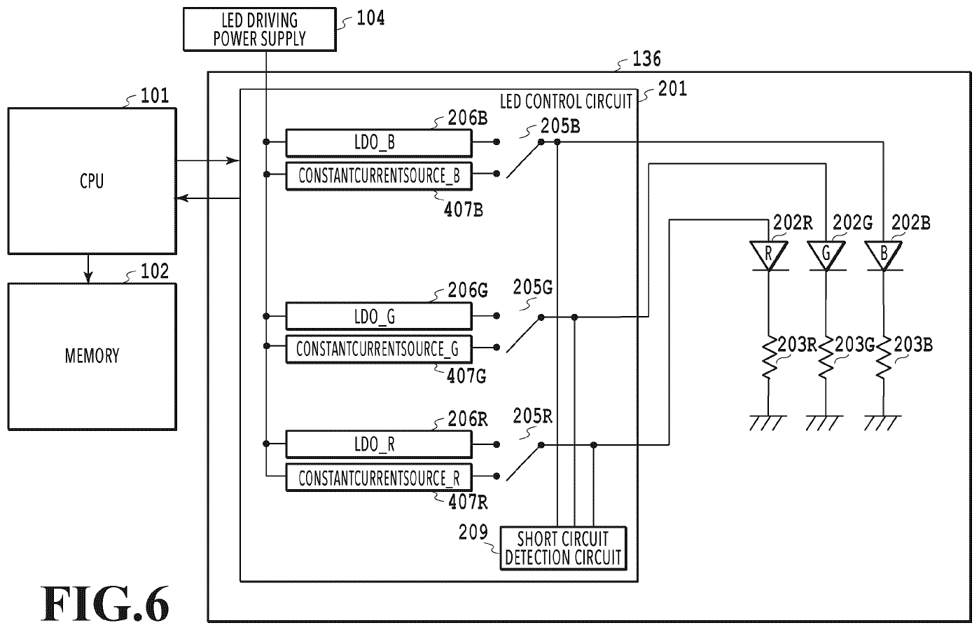

FIG. 6 is a circuit configuration diagram illustrating details of the circuit of an LED control unit 136 in Embodiment 3 corresponding to FIG. 1. The circuit configuration differs from that in Embodiment 1 in that while the configuration in Embodiment 1 uses feedback circuits, feedback control capacitors, and FETs to perform constant current control for LEDs, constant current sources 407R, 407G, and 407B are used in Embodiment 3. In a case of performing short circuit detection on the LEDs 202, it is performed by the same method as that in Embodiment 1. Each LDO forms a first adjustment unit that outputs its output voltage value as a first voltage which is less than the voltage Vf for the corresponding LED 202R, 202G, or 202B. In a case of causing the LEDs to emit light, the constant current sources 407R, 407G, and 407B each function as a second adjustment unit to output a current matching a predetermined value of luminance of light to be emitted so that a voltage higher than or equal to the voltage Vf for the corresponding LED will be output.

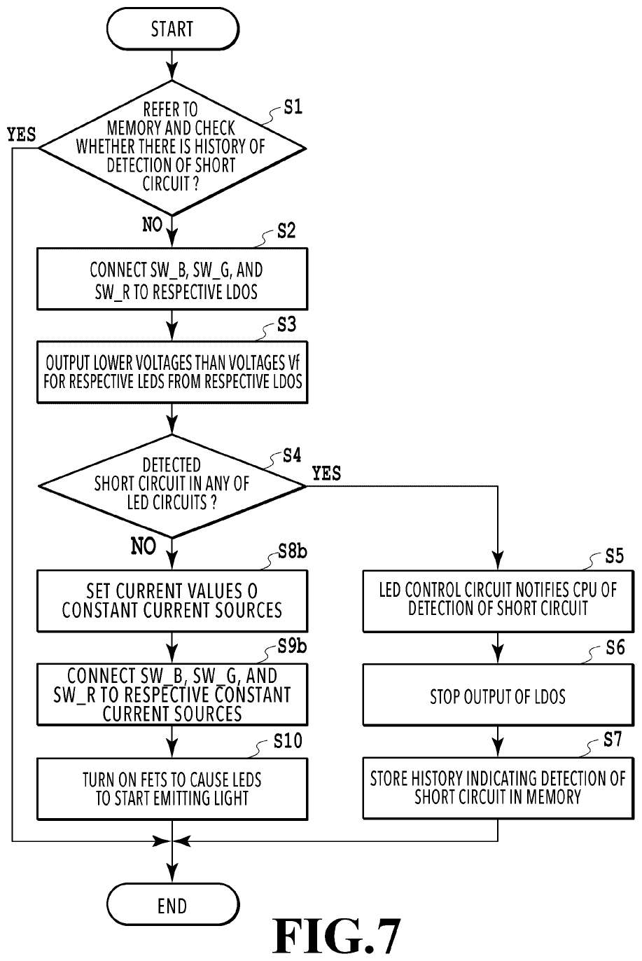

A flow for performing short circuit detection on the LEDs and lighting the LEDs in Embodiment 3 will now be described below with FIG. 7 focusing only on the differences from Embodiment 1. A flow for performing short circuit detection on the LEDs and lighting the LEDs in the present embodiment will now be described. As in Embodiment 1, the timing for implementing the short circuit detection flow in FIG. 7 is desirably a timing at which the image printing apparatus 110 illustrated in FIG. 1 shifts from the off state to the on state. The flow differs from that in Embodiment 1 in that short circuit detection is performed in steps S1 to S4 and then the current value of each constant current source is set in step S8b. Then, in step S9b, the SWs 205R, 205G, and 205B are connected to the constant current sources 407R, 407G, and 407B. In step S10, the constant current sources output currents to the respective LEDs. As a result, the LEDs start emitting light.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefits of Japanese Patent Application No. 2023-134531, filed Aug. 22, 2023, which is hereby incorporated by reference wherein in its entirety.

What is claimed is:

1. A light emitting diode (LED) control apparatus comprising:
an LED;
a power supply that supplies electric power to the LED;
a first adjustment unit that outputs a first voltage out of an input voltage from the power supply to the LED, the first voltage being less than a predetermined voltage;
a second adjustment unit that outputs a second voltage out of an input voltage from the power supply to the LED, the second voltage being more than or equal to the predetermined voltage;
a switch control unit that switches a connection destination for the LED to the first adjustment unit or to the second adjustment unit; and
a detection circuit that, in a case where the first adjustment unit is connected to the LED by the switch control unit and outputs the first voltage, detects a flow of a current of a larger value than a predetermined range of current values through a circuit to which the LED is connected.

2. The LED control apparatus according to claim 1, wherein the LED is an LED complex including a plurality of LED elements.

3. The LED control apparatus according to claim 1, wherein the first adjustment unit is a low-dropout regulator or a variable voltage source.

4. The LED control apparatus according to claim 1, wherein the predetermined voltage is a forward voltage for the LED.

5. The LED control apparatus according to claim 1, wherein the second adjustment unit is a field effect transistor.

6. The LED control apparatus according to claim 1, wherein the detection circuit is connected between the switch control unit and the LED.

7. The LED control apparatus according to claim 1, further comprising a storage unit that stores a result of the detection by the detection circuit, wherein
the switch control unit does not apply a voltage to the LED control apparatus in a case where the storage unit contains a history indicating a current of a larger value than the predetermined range of current values has flowed through the circuit to which the LED is connected.

8. The LED control apparatus according to claim 1, wherein the LED emits light in a case where the LED is connected to the second adjustment unit and the second voltage, which is more than or equal to the predetermined voltage, is applied to the LED.

9. An image printing apparatus comprising:
an LED control apparatus including
an LED,
a power supply that supplies electric power to the LED,
a first adjustment unit that outputs a first voltage out of an input voltage from the power supply to the LED, the first voltage being less than a predetermined voltage,
a second adjustment unit that outputs a second voltage out of an input voltage from the power supply to the LED, the second voltage being more than or equal to the predetermined voltage,
a switch control unit that switches a connection destination for the LED to the first adjustment unit or to the second adjustment unit, and
a detection circuit that, in a case where the first adjustment unit is connected to the LED by the switch control unit and outputs the first voltage, detects a flow of a current of a larger value than a predetermined range of current values through a circuit to which the LED is connected; and
a printing unit that performs printing on a print medium.

10. The image printing apparatus according to claim 9, wherein in a case where the first adjustment unit is connected to the LED and outputs the first voltage in activation of a power supply of the image printing apparatus, the detection circuit detects a flow of a current of a larger value than the predetermined range of current values through the circuit to which the LED is connected.

11. An LED control method comprising:
supplying electric power to an LED from a power supply;
connecting a first adjustment unit to the LED and outputting a first voltage out of an input voltage from the power supply to the LED, the first voltage being less than a predetermined voltage;
in a case where the first voltage is output, detecting a flow of a current of a larger value than a predetermined range of current values through a circuit to which the LED is connected; and
switching a connection destination for the LED to the second adjustment unit and outputting a second voltage out of an input voltage from the power supply to the LED, the second voltage being more than or equal to the predetermined voltage.
